(19) United States
(12) Patent Application Publication
(10) Pub. No.: US 2023/0058252 A1
(43) Pub. Date: Feb. 23, 2023

(54) LID DEVICE

(71) Applicant: HONDA MOTOR CO., LTD., Tokyo (JP)

(72) Inventor: Tomonori WATANABE, Tokyo (JP)

(21) Appl. No.: 17/890,356

(22) Filed: Aug. 18, 2022

(30) Foreign Application Priority Data
Aug. 20, 2021 (JP) 2021-134893

(51) Int. Cl. E05B 81/70; E05B 83/34; B60K 15/05; E05B 49/00

(52) U.S. Cl. CPC E05B 81/70; E05B 83/34; B60K 15/05; E05B 49/00; B60K 2015/0561

(57) ABSTRACT

A lid device includes: a lid; a lid switch that detects displacement of the lid to each of an open position for opening an opening, a closed position for closing the opening, a push start position located further in the closing direction than the closed position, and a pushed-in position located further in the closing direction than the push start position; and a control device that determines a lid switch status based on a detection result of the lid switch and controls an indicator to display the lid switch status. The control device determines that the lid switch status is in an open state when the lid switch detects displacement of the lid to the open position or the push start position and determines that the lid switch status is in a closed state when the lid switch detects displacement of the lid to the closed position or pushed-in position.

### TECHNICAL FIELD

The present invention relates to a lid device, and more specifically relates to a lid device for opening and closing an opening provided to a vehicle such as an automobile for energy replenishment or external power feeding.

### BACKGROUND ART

A body of a vehicle such as an automobile is usually provided with an opening for energy replenishment or external power feeding, such as an opening for fuel replenishment or an opening for electric charging. As a lid device for opening and closing such an opening provided in the vehicle body, there is known a lid device including: a lid provided on the vehicle body to be displaceable between an open position where the lid opens the opening, a closed position where the lid closes the opening, and an overstroke position which is located further in the closing direction than the closed position; a lock mechanism that latches the lid in the closed position; a lock drive unit, such as an electric motor, that drives the lock mechanism; and a control device that controls the lock drive unit (see JP2021-038566A).

This lid device further includes a lid switch that detects displacement of the lid to each of the open position, the closed position, and the overstroke position. The lid switch includes an operation rod that is displaced upon contact with the lid and a micro switch that is opened and closed by displacement of the operation rod. The operation rod has a cam part at an intermediate portion thereof with respect to the axial direction such that the cam part includes a recess which is selectively engaged with an operation member of the micro switch. When the lid is in the closed position, the recess of the operation rod is engaged with the operation member of the micro switch and the contacts of the micro switch open. When the lid is in the fully open position or the open position, the recess of the operation rod is separated from the operation member of the micro switch in the opening direction and the contacts of the micro switch are closed. When the lid is in the overstroke position, the recess of the operation rod is separated from the operation member of the micro switch in the closing direction and the contacts of the micro switch are closed. The control device determines a lid switch status, which indicates the open/closed state of the lid, based on the detection result of the lid switch.

The control device controls the lock drive unit to release the lock mechanism when the lid switch status is switched from OFF (closed state) to ON (overstroke state). Also, the control device controls an indicator to display the open/closed state of the lid (the determined lid switch status).

The turn-on condition of the lid switch status is changing of the lid switch from OFF to ON. On the other hand, the turn-off condition of the lid switch status is that the lid switch is maintained OFF for a predetermined time (second predetermined time Tb) or longer. Namely, after the displacement of the lid to the overstroke position is detected by the lid switch (after the lid switch is turned from OFF to ON), the control device ignores the turning of the lid switch from ON to OFF until the lid switch is maintained OFF for the predetermined time or longer. Accordingly, the control device determines that the lid switch status is ON when the lid is displaced to the overstroke position, and maintains the lid switch status ON when the lid, which has become displaceable to the open position due to release of the lock mechanism, passes the closed position.

However, if the lid switch status is determined as in the lid device disclosed in JP2021-038566A, the actual position of the lid and the lid switch status determined by the control device can differ from each other. For example, in a case where the lid is displaced to the overstroke position and thereafter is maintained in the overstroke position, the lid switch status is determined to be ON (open state) by the control device when the lid is displaced to the overstroke position and is maintained ON. Also, the control device makes the indicator display that the lid (lid switch status) is in the open state. Therefore, the lid switch status displayed on the indicator and the actual open/closed state of the lid become mismatched. Further, in a case where the lid switch status determined by the control device is transmitted to and used by another control unit, for example, since the lid switch status is determined to be the open state, in appropriate operations such as improper issuance of warning and turning on of light may occur.

### SUMMARY OF THE INVENTION

In view of the foregoing background, a primary object of the present invention is to more accurately determine the lid switch status indicating the open/closed state of the lid and to prevent mismatch between the lid switch status displayed on the indicator and the actual open/closed state of the lid.

To achieve the above object, one aspect of the present invention provides a lid device (20) for covering an opening (16) provided in a vehicle body (10) to enable at least one of energy replenishment and external power feeding, the lid device comprising: a lid (22) displaceably provided on the vehicle body to selectively open and close the opening; a lid switch (40) that detects displacement of the lid to each of an open position where the lid opens the opening, a closed position which is located in a closing direction relative to the open position and in which the lid closes the opening, a push start position located further in the closing direction than the closed position, and a pushed-in position located further in the closing direction than the push start position; an indicator (58) provided inside a vehicle; and a control device (54) that determines a lid switch status indicating an open/closed state of the lid based on a detection result of the lid switch and controls the indicator to display the lid switch status, wherein the control device determines that the lid switch status is in an open state when the lid switch detects displacement of the lid to the open position or the push start position and determines that the lid switch status is in a closed state when the lid switch detects displacement of the lid to the closed position or the pushed-in position.

According to this aspect, the control device determines the lid switch status to be the open state when the lid switch detects that the lid has been displaced from the closed position to the push start position. Thereafter, the control device can determine the lid switch status to be the closed state when the lid switch detects that the lid has been displaced from the push start position to the pushed-in position. Therefore, the control device can more accurately determine the lid switch status indicating the open/closed state of the lid, whereby mismatch between the lid switch status displayed on the indicator and the actual open/closed state of the lid can be prevented.

In the above aspect, preferably, the control device determines the lid switch status to be the open state when displacement of the lid from the closed position to the push start position is detected by the lid switch (t1, t11) and determines the lid switch status to be the closed state when displacement of the lid from the push start position to the pushed-in position continues to be detected by the lid switch for a first predetermined time (Ta) (at the time point t13).

According to this aspect, the first predetermined time is set as a required continuation time till the lid switch status is determined to be the closed state. Thereby, the lid switch status is prevented from switching frequently.

In the above aspect, preferably, the first predetermined time is set as a time equal to or longer than a time required for the lid to pass the pushed-in position in a process of opening operation in which a user pushes in the lid in the closed position toward the pushed-in position and releases a hand from the lid immediately after the lid is displaced to the pushed-in position (such a first predetermined time may be 200 ms, for example).

According to this aspect, when the user performs the opening operation to open the lid, the lid switch status is prevented from momentarily switching to the closed state.

In the above aspect, preferably, the control device makes the indicator display the open state when the lid switch status continues to be the open state for a second predetermined time (Tb) longer than the first predetermined time (t6, t18).

According to this aspect, the open state is displayed on the indicator after the lid switch status is maintained in the open state for the second predetermined time longer than the first predetermined time. Therefore, occurrence of a mismatched state in which the open state is displayed on the indicator even though the lid is not open is avoided.

Preferably, the second predetermined time is set as a time equal to or longer than a time required for the lid to be displaced to the open position from a time point (t1) where displacement of the lid from the closed position to the push start position is detected by the lid switch (the time from the time point t1 to the time point t5) in the process of the opening operation. Such a second predetermined time may be 500 ms, for example.

According to this aspect, when the user performs the opening operation to open the lid, the open state is not displayed on the indicator before the lid is displaced to the open position.

In the above aspect, preferably, the lid switch is ON when the lid is positioned in the open position or the push start position and is OFF when the lid is positioned in the closed position or the pushed-in position. In a case where the lid switch is turned from OFF to ON (at the time point t3) before the first predetermined time elapses from a time point (t2) where the lid switch is turned from ON to OFF due to displacement of the lid from the push start position to the pushed-in position, it is preferred that the control device makes the indicator display the open state when the lid switch status continues to be the open state for the second predetermined time (at the time point t6) from a time point (t1) where the lid switch is turned from OFF to ON due to displacement of the lid from the closed position to the push start position. On the other hand, in a case where the lid switch is turned from OFF to ON (at the time point t15) after the first predetermined time has elapsed (at the time point t13) from the time point (t12) where the lid switch is turned from ON to OFF due to displacement of the lid from the push start position to the pushed-in position, it is preferred that the control device makes the indicator display the open state when the lid switch status continues to be the open state for the second predetermined time (at the time point t18) from the time point (t15) where the lid switch is turned from OFF to ON due to displacement of the lid from the pushed-in position to the push start position.

According to this aspect, when the user pushes in the lid and releases the hand immediately, the open state is displayed on the indicator without a delay relative to the displacement of the lid to the open position in response to the user's opening operation. On the other hand, when the user continues to push the lid to the pushed-in position, display of the open state on the indicator can be delayed corresponding to the displacement of the lid to the open position which is delayed depending on the push-in time.

In the above aspect, preferably, the lid switch comprises an operation rod (44) extending in a direction toward and away from an inner surface of the lid in the closed position and supported to be movable in an axial direction and a switch operation member (48A) that operates in accordance with displacement of the operation rod in the axial direction, and the operation rod has a first recess (50A) and a second recess (50B) provided to be arranged side by side in the axial direction such that the switch operation member is engaged with the first recess when the lid is displaced to the closed position and is engaged with the second recess when the lid is displaced to the pushed-in position.

According to this aspect, without using complex-shaped components or a complex configuration constituted of many parts, a lid switch capable of detecting displacement of the lid to each of the open position, the closed position, the push start position, and the pushed-in position can be embodied with a simple configuration using simple-shaped components.

Thus, it is possible to more accurately determine the actual state of the lid and to prevent mismatch between the open/closed state of the lid displayed on the indicator and the actual open/closed state of the lid.

### BRIEF DESCRIPTION OF THE DRAWINGS

FIG. 1 is a sectional view showing an embodiment of a lid device according to the present invention;

FIG. 2 is an explanatory diagram schematically showing the lid device according to the embodiment;

FIG. 3 is an explanatory diagram schematically showing various states of a lid switch used in the lid device according to the embodiment;

FIG. 4 is a time chart of the lid device according to the embodiment; and

FIG. 5 is a time chart of the lid device according to the embodiment.

### DETAILED DESCRIPTION OF THE INVENTION

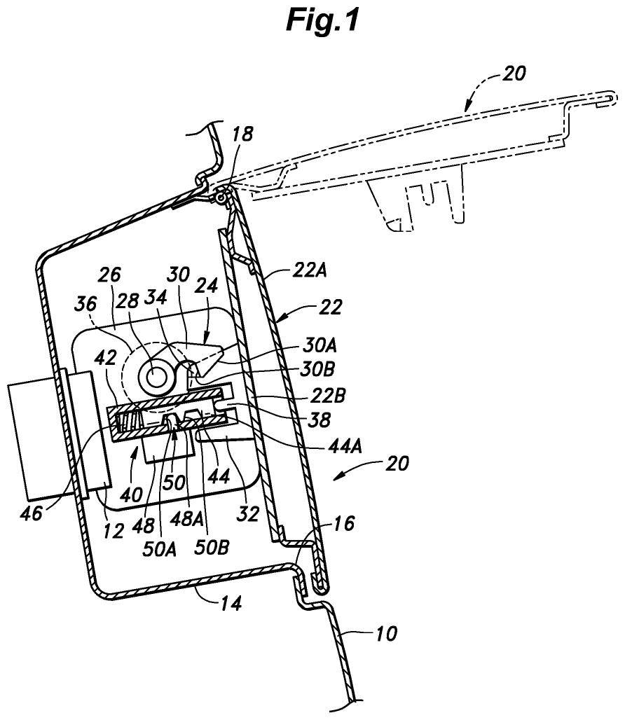

In the following, an embodiment of a lid device 20 according to the present invention will be described with reference to FIGS. 1 to 6.

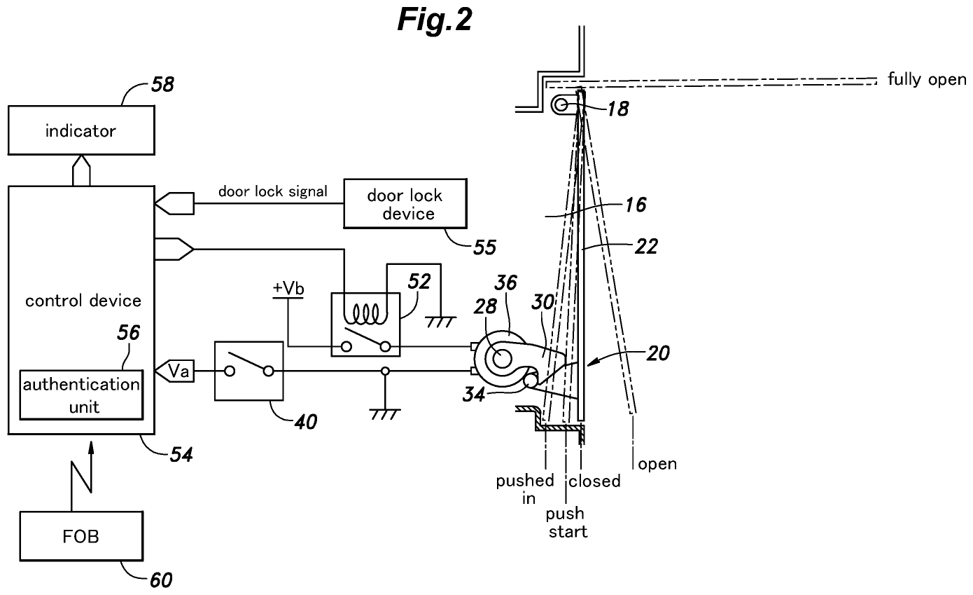

As shown in FIGS. 1 and 2, a charging box 14 having a charging/power feeding socket 12 (charging/power feeding inlet) built therein is mounted on a vehicle body 10 (outer panel) of a plug-in hybrid car or an electric car. The charging/power feeding socket 12 is used in charging of onboard batteries (not shown in the drawings) by external power feeding and in power feeding in which the electric power of the onboard batteries is fed to the outside.

The charging box 14 defines a charging/power feeding opening 16 that opens toward the outside of the vehicle body 10 as an energy replenishment and external power feeding opening. The vehicle body 10 is provided with a lid device 20 for opening and closing the charging/power feeding opening 16. The lid device 20 includes a lid 22 pivotably mounted on the charging box 14 via a hinge 18. The lid 22 includes an outer plate 22A and an inner plate 22B. Note that the lid 22 may be mounted on the vehicle body 10 instead of on the charging box 14 via the hinge 18.

The lid 22 is displaceable between a fully open position (position indicated by an imaginary line in FIG. 1) where the lid 22 opens the charging/power feeding opening 16 and a closed position (position indicated by a solid line in FIG. 1) which is located in the closing direction relative to the fully open position and in which the lid 22 closes the charging/power feeding opening 16. Also, the lid 22 is displaceable between the closed position and a pushed-in position (see FIG. 2) which is located further in the closing direction than the closed position. Upon a later-described opening operation, the lid 22 is displaced from the closed position to an open position (see FIG. 2) which is located between the closed position and the fully open position. The open position of the lid 22 is located slightly in the opening direction relative to the closed position. The lid 22 is displaced by manual operation from the open position to the fully open position and is selectively held in the fully open position by the friction of the hinge 18 or by a spring (not shown in the drawings) and the like.

As shown in FIG. 1, the lid device 20 includes an electric lock mechanism 24. The lock mechanism 24 includes a mounting board 26 fixed to the charging box 14 and a locking claw 30 pivotably mounted to the mounting board 26 via a support shaft 28.

The locking claw 30 is in a hook shape having an inclined surface 30A and an upright surface 30B and is selectively engaged with an engagement projection 34 of an operation member 32 mounted on the inner plate 22B of the lid 22. When engaged with the engagement projection 34, the locking claw 30 latches the lid 22 in the closed position by the upright surface 30B positioned in the opening direction relative to the engagement projection 34 to prohibit displacement of the lid 22 to the open position while allowing displacement of the lid to the pushed-in position.

An electric motor 36 serving as a lock drive unit is mounted on the mounting board 26. The electric motor 36 is coupled to the support shaft 28 and when energized, causes the locking claw 30 to rotate counterclockwise as viewed in FIG. 1 from the lock position in which the locking claw 30 is engaged with the engagement projection 34 as shown in FIG. 1, thereby to bring the locking claw 30 in the unlock position in which the locking claw 30 is disengaged from the engagement projection 34. When in the unlock position, the locking claw 30 permits displacement of the lid 22 from the closed position to the open position.

Note that the locking claw 30 is urged toward the lock position by a return spring not shown in the drawings so that when the electric motor 36 is not energized, the locking claw 30 is returned to the lock position by the spring force of the return spring. When the lid 22 returns from the fully open position or the open position to the closed position under the non-energization state of the electric motor 36, the inclined surface 30A of the locking claw 30 functions as a cam surface. Specifically, as a result of contact of the engagement projection 34 with the inclined surface 30A, the locking claw 30 rotates against the spring force of the return spring, and after the engagement projection 34 has passed over the inclined surface 30A, is automatically returned by the spring force of the return spring to the lock position where the locking claw 30 is engaged with the engagement projection 34.

A lid switch 40 is mounted on the mounting board 26. The lid switch 40 includes a rod support member 42 fixed to the mounting board 26 and an operation rod 44 supported by the rod support member 42. The operation rod 44 extends in a direction toward and away from the inner surface of the lid 22 positioned in the closed position and is movable in the extension direction (axial direction). The operation rod 44 is urged by a rod urging spring 46 toward the lid 22. A micro switch 48 is mounted on the mounting board 26 such that the micro switch 48 opens and closes in accordance with displacement of the operation rod 44 in the axial direction. The micro switch 48 includes a switch operation member 48A urged toward the operation rod 44 and operates in accordance with displacement of the operation rod 44 in the axial direction, so that the micro switch 48 opens and closes in accordance with the operation of the switch operation member 48A.

The operation rod 44 has an axial end 44A that separably contacts a rod operation projection 38 formed on the operation member 32. Thereby, the rod urging spring 46 also functions as a lid urging spring that urges the lid 22 via the operation rod 44 from the pushed-in position in the opening direction, so that the number of components including the springs is reduced.

An axially intermediate portion of the operation rod 44 is provided with a cam part 50 including two recesses (hereinafter referred to as a first recess 50A and a second recess 50B) which are arranged side by side in the axial direction and engaged with the switch operation member 48A of the micro switch 48.

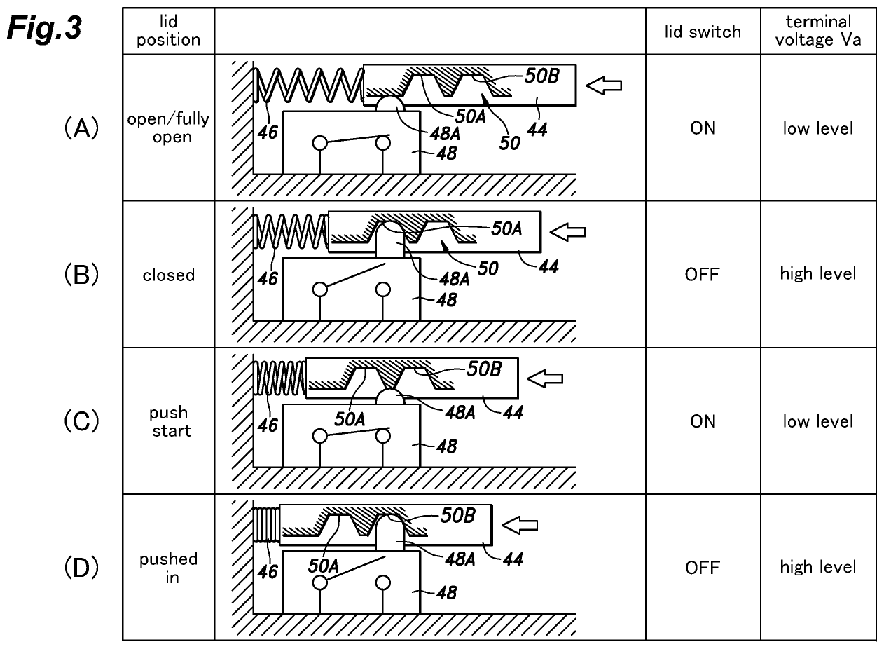

When the lid 22 is in the fully open position or the open position, as shown in (A) of FIG. 3, the operation rod 44 is displaced to the rightmost position by the spring force of the rod urging spring 46. At this time, the first recess 50A and the second recess 50B of the cam part 50 are both spaced from the switch operation member 48A to the right and the contacts of the micro switch 48 are closed. Thereby, the lid switch 40 is ON and the terminal voltage Va of the lid switch 40 is at the low level.

When the lid 22 is in the closed position, as shown in (B) of FIG. 3, the operation rod 44 is displaced to the left against the spring force of the rod urging spring 46. At this time, the first recess 50A of the cam part 50 is engaged with the switch operation member 48A and the contacts of the micro switch 48 open. Thereby, the lid switch 40 is OFF and the terminal voltage Va is at the high level.

When the lid 22 positioned in the closed position starts being pushed in, as shown in (C) of FIG. 3, the operation rod 44 is displaced further to the left against the spring force of the rod urging spring 46. At this time, the first recess 50A of the cam part 50 is spaced from the switch operation member 48A to the left, and the second recess 50B is spaced from the switch operation member 48A to the right. In other words, the switch operation member 48A is positioned between the first recess 50A and the second recess 50B, and the contacts of the micro switch 48 are closed. Thereby, the lid switch 40 is ON and the terminal voltage Va is at the low level.

In the following, this position of the lid 22 will be referred to as a push start position (also see FIG. 2). It should be noted that not only when the user starts pushing in the lid 22 positioned in the closed position but also when the lid 22 positioned in the pushed-in position starts returning toward the closed position also, the lid 22 passes this position.

When the lid 22 is in the pushed-in position, as shown in (C) of FIG. 3, the operation rod 44 is displaced further to the left against the spring force of the rod urging spring 46. At this time, the first recess 50A and the second recess 50B of the cam part 50 are both spaced from the switch operation member 48A to the left and the contacts of the micro switch 48 open. Thereby, the lid switch 40 is OFF and the terminal voltage Va is at the high level.

In this way, the lid switch 40 is configured to detect displacement of the lid 22 to each of the open position, the closed position, the push start position, and the pushed-in position based on the terminal voltage Va.

Specifically, the first recess 50A which is engaged with the switch operation member 48A when the lid 22 is displaced to the closed position and the second recess 50B which is engaged with the switch operation member 48A when the lid 22 is displaced to the pushed-in position are provided in the operation rod 44 to be arranged side by side in the axial direction. Thereby, without using complex-shaped components or a complex configuration constituted of many parts, the lid switch 40 capable of detecting displacement of the lid 22 to each of the open position, the closed position, the push start position, and the pushed-in position can be embodied with a simple configuration using simple-shape components.

As shown in FIG. 2, the electric motor 36 is energized and de-energized according to closing and opening of a normally-open relay switch 52 provided in the power supply circuit with a battery voltage Vb. The closing and opening of the relay switch 52, in other words, ON/OFF of the relay output, is controlled by a control device 54.

The control device 54 is constituted of a microcomputer provided with a computational processing device (s processor such as a CPU and an MPU) and a storage device (memory such as a ROM and a RAM) and configured to execute various processing. The control device 54 receives the terminal voltage Va of the lid switch 40 indicating ON/OFF of the lid switch 40 which is the detection result and determines the lid switch status indicating the open/closed state of the lid 22 based on the detection result of the lid switch 40. The control device 54 also controls the display of the lid switch status on the indicator 58. The indicator 58 is provided inside the vehicle such as on the instrument panel, for example, to be within the driver's field of view. Further, the control device 54 receives a door lock signal from a door lock device 55 of the driver's seat and controls ON/OFF of the relay output.

The control device 54 further includes an authentication unit 56 which performs authentication (ID matching) of the legitimate user by performing wireless communication with a portable electronic key (FOB) 60 which is also referred to as a smart key. The authentication unit 56 performs the authentication process electronically according to a known procedure when the door lock device 55 is in the locked state (in other words, when the door is locked), for example. The authentication unit 56 starts the authentication process when it is detected that the lid 22 positioned in the closed position is pushed by the user and is displaced to the pushed-in position based on turning of the lid switch 40 from OFF to ON and subsequent turning of the same from ON to OFF.

When the door is locked, the control device 54 does not provide the relay output for closing the relay switch 52 unless the authentication process is completed properly, namely, does not control the relay switch 52 in the case of NG determination. Thereby, the lock mechanism 24 of the lid 22 cannot be released by a non-user for whom the authentication process will not be completed properly, and this provides a security measure.

When the door lock device 55 is in the unlocked state (in other words, when the door is unlocked), the control device 54 closes the relay switch 52 without performing the authentication process when it is detected that the lid 22 positioned in the closed position is pushed by the user and is displaced to the pushed-in position.

Thereby, when the door is unlocked, the release operation of the lock mechanism 24 by the electric motor 36 is immediately started at the time point where the lid 22 is displaced from the closed position to the pushed-in position. Once the locking claw 30 is rotated to the unlock position upon this release operation, the lid 22 can be displaced from the pushed-in position to the open position via the push start position and the closed position. The lid 22 displaced to the open position can be displaced to the fully open position manually. When the lid 22 is displaced to the fully open position, the charging/power feeding opening 16 is opened so that the charging and power feeding are allowed.

An operation of closing the lid 22 displaced to the fully open position is performed by manually returning the lid 22 to the closed position, the push start position, or the pushed-in position. At this time, if the ON output to the relay switch 52 from the control device 54 has terminated and the locking claw 30 has automatically returned to the lock position, the lid 22 is latched in the closed position by the lock mechanism 24.

Next, a lid switch status determination process executed by the control device 54 will be described. The lid switch status is determined by the control device 54 and is used in the control of the lid device 20. As described with reference to FIG. 3, the lid switch 40 is ON when the lid 22 is in the fully open position, the open position, or the push start position, and is OFF when the lid 22 is in the closed position or the pushed-in position. In other words, the control device 54 determines the lid switch status to be the open state when the lid switch 40 detects displacement of the lid 22 to the open position or the push start position. Also, the control device 54 determines the lid switch status to be the closed state when the lid switch 40 detects displacement of the lid 22 to the closed position or the pushed-in position. It should be noted, however, that conditions are set for switching the lid switch status between the open state and the closed state.

By thus determining the lid switch status, the control device 54 determines the lid switch status to be the open state when the displacement of the lid 22 from the closed position to the push start position is detected. Thereafter, when the displacement of the lid 22 from the push start position to the pushed-in position is detected, the control device 54 can determine the lid switch status to be the closed state. Therefore, the control device 54 can accurately determine the lid switch status indicating the open/closed state of the lid 22, so that mismatch between the lid switch status displayed on the indicator 58 and the actual open/closed state of the lid 22 is prevented.

The condition for the control device 54 to switch the lid switch status from the closed state to the open state and the condition for the control device 54 to switch the lid switch status from the open state to the closed state are set as follows. The switching condition of the lid switch status from the closed state to the open state is changing of the lid switch 40 from OFF to ON. The switching condition of the lid switch status from the open state to the closed state is maintaining of the OFF state of the lid switch 40 for a first predetermined time Ta or longer. In other words, the control device 54 switches the lid switch status from the closed state to the open state immediately when the lid switch 40 is turned from OFF to ON. Also, the control device 54 switches the lid switch status from the open state to the closed state when the first predetermined time Ta elapses with the lid switch 40 being continuously OFF from the time point where the lid switch 40 is turned from ON to OFF.

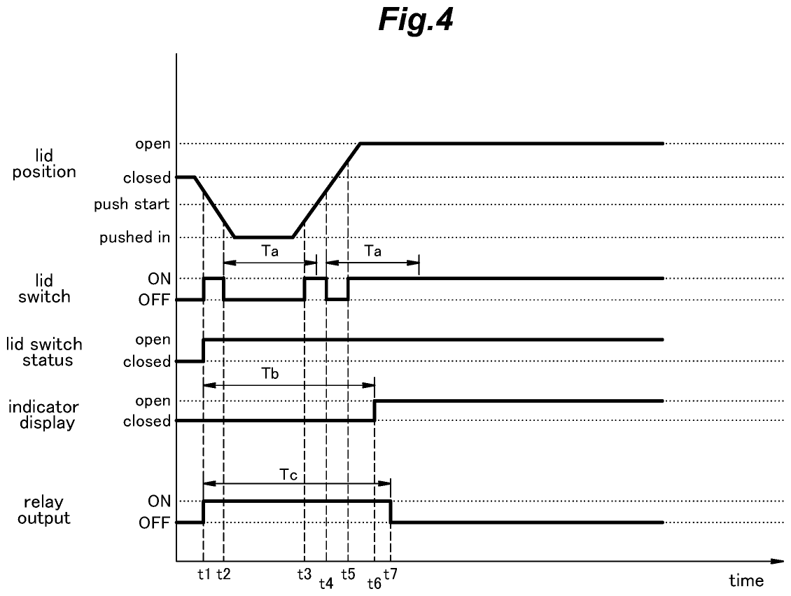

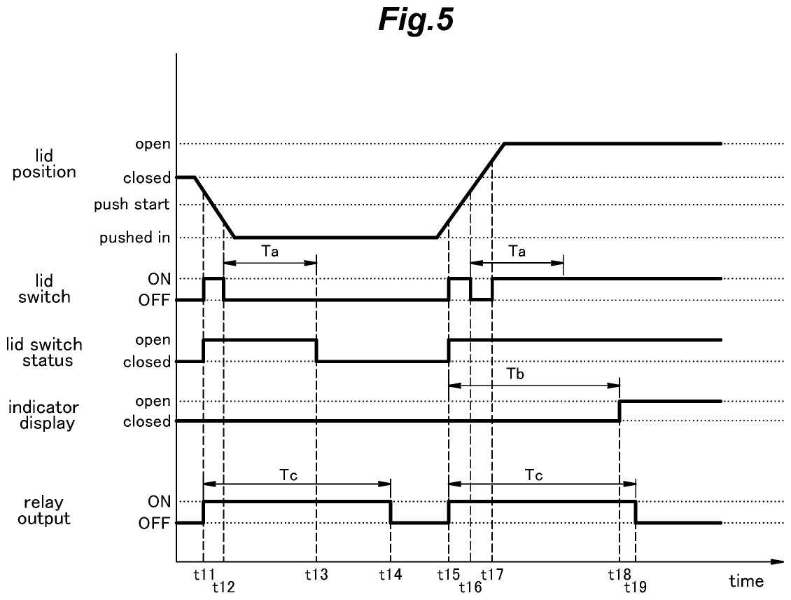

With reference to the time charts shown in FIGS. 4 and 5, the operation of the lid device 20 and the control performed by the control device 54 will be described. FIG. 4 is a time chart of the lid device 20 when the user performs an ordinary opening operation. FIG. 5 is a time chart when the user pushes the lid 22 to the pushed-in position for a period longer than the ordinary opening operation.

As shown in FIG. 4, when the lid 22 positioned in the closed position is pushed by the user, the lid position changes from the closed position to the push start position and to the pushed-in position successively. At the time point t1 where the lid 22 is displaced from the closed position to the push start position, the lid switch 40 is turned from OFF to ON. At this time point t1, the control device 54 switches the lid switch status from the closed state to the open state.

At the time point t2 where the lid 22 is displaced from the push start position to the pushed-in position, the lid switch 40 is turned from ON to OFF. The lid switch status is not switched from the open state to the closed state unless the first predetermined time Ta elapses from this time point t2 with the lid switch 40 being continuously OFF.

Thus, since the first predetermined time Ta is set as a required continuation time till the lid switch status is determined to be the closed state, the lid switch status is prevented from switching frequently.

The first predetermined time Ta is set as follows. When opening the lid 22, the user usually pushes in the lid 22 positioned in the closed position with a hand toward the pushed-in position, and immediately after the lid 22 is displaced to the pushed-in position, the user releases the hand from the lid 22. The first predetermined time Ta is set to a time equal to or longer than a time required for the lid 22 to pass the pushed-in position in such a process of the opening operation. The first predetermined time Ta may be set to 200 ms, for example.

Thereby, when the user performs the opening operation of opening the lid 22, the lid switch status is prevented from momentarily switching to the closed state.

In the example of FIG. 4, the user performs an ordinary opening operation, and the lid 22 is displaced from the pushed-in position toward the open position before the first predetermined time Ta elapses from the time point t2 where the lid 22 is displaced from the push start position to the pushed-in position. At the time point t3 where the lid 22 is displaced from the pushed-in position to the push start position, the lid switch 40 is turned from OFF to ON, and at the time point t4 where the lid 22 is displaced from the push start position to the closed position, the lid switch 40 is turned from ON to OFF. Subsequently, at the time point t5 where the lid 22 is displaced from the closed position to the open position, the lid switch 40 is turned from OFF to ON.

The lid switch status is maintained in the open state because the lid switch 40 is turned from OFF to ON before the first predetermined time Ta elapses from the time point t2. The control device 54 switches the display on the indicator 58 from the closed state to the open state at the time point t6 where the lid switch status has continued to be the open state for a second predetermined time Tb, which is longer than the first predetermined time Ta, from the time point t1. Namely, the control device 54 makes the indicator 58 display the open state at the time point t6.

In this way, the open state is displayed on the indicator 58 after the lid switch status is maintained in the open state for the second predetermined time Tb which is longer than the first predetermined time Ta. Therefore, occurrence of a mismatched state in which the open state is displayed on the indicator 58 even though the lid 22 is not open is avoided.

The second predetermined time Tb is set to a time equal to or longer than a time required for the lid 22 to be displaced to the open position from the time point t1 where the displacement of the lid 22 from the closed position to the push start position is detected by the lid switch 40 (the time from the time point t1 to the time point t5) in the process of the opening operation. The second predetermined time Tb may be set to 500 ms, for example.

Thereby, when the user performs the opening operation to open the lid 22, the open state is not displayed on the indicator 58 before the lid 22 is displaced to the open position.

Note that at the time point t1 where the lid 22 is displaced from the closed position to the push start position, the control device 54 switches the relay output from OFF to ON to drive the electric motor 36 of the lock mechanism 24, and maintains the relay output ON for a third predetermined time Tc longer than the second predetermined time Tb. Thereby, when the lid 22 is displaced to the open position via the closed position in the process of the ordinary opening operation, the locking claw 30 is in the unlock position to permit the displacement of the lid 22 to the open position.

Next, the example of FIG. 5 will be described. At the time point t11 where the lid 22 is displaced from the closed position to the push start position, the lid switch 40 is turned from OFF to ON. At this time point t1, the control device 54 switches the lid switch status from the closed state to the open state. At the time point t12 where the lid 22 is displaced from the push start position to the pushed-in position, the lid switch 40 is turned from ON to OFF. In this example, the lid position is held in the pushed-in position longer compared to the example of FIG. 4, and the first predetermined time Ta elapses from the time point t12 with the lid switch 40 being continuously OFF. Thus, the control device 54 switches the lid switch status from the open state to the closed state at the time point t13 where the first predetermined time Ta elapses from the time point t12.

The control device 54 switches the relay output of the lock mechanism 24 from OFF to ON at the time point t11 where the displacement of the lid 22 from the closed position to the push start position is detected by the lid switch 40. The control device 54 maintains the relay output ON for the third predetermined time Tc which is longer than the second predetermined time Tb. However, the lid position is held in the pushed-in position beyond the time point t14 where the third predetermined time Tc elapses from the time point t11. Since the relay output is turned from ON to OFF at the time point t14, the locking claw 30 returns to the lock position after the time point t14.

Thereafter, the pushing of the lid 22 is released, and the lid 22 is displaced from the pushed-in position toward the open position. At the time point t15 where the lid 22 is displaced to the push start position, the lid switch 40 is turned from OFF to ON and at the time point t16 where the lid 22 is displaced from the push start position to the closed position, the lid switch 40 is turned from ON to OFF. Subsequently, at the time point t17 where the lid 22 is displaced from the closed position to the open position, the lid switch 40 is turned from OFF to ON.

At the time point t15 where the lid switch 40 is turned from OFF to ON, the control device 54 switches the lid switch status from the closed state to the open state. Since the lid switch 40 is turned from OFF to ON before the first predetermined time Ta elapses from the time point t15, the lid switch status is maintained in the open state.

In the example of FIG. 5, the lid switch 40 is turned from OFF to ON at the time point t15 which is after the time point t13 where the first predetermined time Ta elapses from the time point t12 where the lid switch 40 is turned from ON to OFF due to the displacement of the lid 22 from the push start position to the pushed-in position. In this case, the control device 54 switches the display on the indicator 58 from the closed state to the open state at the time point t18 where the lid switch status has continued to be the open state for the second predetermined time Tb from the time point t15 where the lid 22 is displaced from the pushed-in position to the push start position. Namely, the control device 54 makes the indicator 58 display the open state at the time point t18.

In other words, the open state is displayed on the indicator 58 after the lid switch status is maintained in the open state for the second predetermined time Tb which is longer than the first predetermined time Ta. Therefore, occurrence of a mismatched state in which the open state is displayed on the indicator 58 even though the lid 22 is not open is avoided.

Note that the control device 54 switches the relay output from OFF to ON to drive the electric motor 36 of the lock mechanism 24 at the time point t15 also where the lid 22 is displaced from the pushed-in position to the push start position. The control device 54 maintains the relay output ON for the third predetermined time Tc, which is longer than the second predetermined time Tb, from the time point t15. Thereby, even in the case where the lid 22 is held in the pushed-in position longer than usual, the locking claw 30 is in the unlock position when the lid 22 passes the closed position to be displaced to the open position to permit displacement of the lid 22 to the open position. The relay output is switched from ON to OFF at the time point t19 where the third predetermined time Tc elapses from the time point t15.

In the example of FIG. 4, the lid switch 40 is turned from OFF to ON at the time point t3 which is before the first predetermined time Ta elapses from the time point t2 where the lid switch 40 is turned from ON to OFF due to the displacement of the lid 22 from the push start position to the pushed-in position. In this case, the control device 54 makes the indicator 58 display the open state at the time point t6 where the lid switch status has continued to be the open state for the second predetermined time Tb from the time point t1 where the lid 22 is displaced from the closed position to the push start position.

Thereby, when the user pushes in the lid 22 and releases the hand immediately, the open state is displayed on the indicator 58 without a delay relative to the displacement of the lid 22 to the open position in response to the user's opening operation.

On the other hand, in the example of FIG. 5, the lid switch 40 is turned from OFF to ON at the time point t15 which is after the time point t13 where the first predetermined time Ta elapses from the time point t12 where the lid switch 40 is turned from ON to OFF due to the displacement of the lid 22 from the push start position to the pushed-in position. In this case, the control device 54 makes the indicator 58 display the open state at the time point t18 where the lid switch status has continued to be the open state for the second predetermined time Tb from the time point t15 where the lid 22 is displaced from the pushed-in position to the push start position.

Thereby, when the user continues to push the lid 22 to the pushed-in position, the display of the open state on the indicator 58 can be delayed corresponding to the displacement of the lid 22 to the open position which is delayed depending on the push-in time.

Concrete embodiments of the present invention have been described in the foregoing, but the present invention is not limited to the above embodiments and may be modified or altered in various ways. For example, the lid device 20 is not limited to a charging lid and may be applied to a fuel lid and the like. The drive unit of the locking claw 30 is not limited to the electric motor 36 but may be embodied as an electromagnetic actuator and the like.

Also, not all of the components shown in the foregoing embodiment are necessarily indispensable and they may be selectively adopted as appropriate without departing from the scope of the present invention.

1. A lid device for covering an opening provided in a vehicle body to enable at least one of energy replenishment and external power feeding, the lid device comprising:
a lid displaceably provided on the vehicle body to selectively open and close the opening;
a lid switch that detects displacement of the lid to each of an open position where the lid opens the opening, a closed position which is located in a closing direction relative to the open position and in which the lid closes the opening, a push start position located further in the closing direction than the closed position, and a pushed-in position located further in the closing direction than the push start position;
an indicator provided inside a vehicle; and
a control device that determines a lid switch status indicating an open/closed state of the lid based on a detection result of the lid switch and controls the indicator to display the lid switch status,
wherein the control device determines that the lid switch status is in an open state when the lid switch detects displacement of the lid to the open position or the push start position and determines that the lid switch status is in a closed state when the lid switch detects displacement of the lid to the closed position or the pushed-in position.

2. The lid device according to claim 1, wherein the control device determines the lid switch status to be the open state when displacement of the lid from the closed position to the push start position is detected by the lid switch and determines the lid switch status to be the closed state when displacement of the lid from the push start position to the pushed-in position continues to be detected by the lid switch for a first predetermined time.

3. The lid device according to claim 2, wherein the first predetermined time is set as a time equal to or longer than a time required for the lid to pass the pushed-in position in a process of opening operation in which a user pushes in the lid in the closed position toward the pushed-in position and releases a hand from the lid immediately after the lid is displaced to the pushed-in position.

4. The lid device according to claim 3, wherein the control device makes the indicator display the open state when the lid switch status continues to be the open state for a second predetermined time longer than the first predetermined time.

5. The lid device according to claim 4, wherein the second predetermined time is set as a time equal to or longer than a time required for the lid to be displaced to the open position from a time point where displacement of the lid from the closed position to the push start position is detected by the lid switch in the process of the opening operation.

6. The lid device according to claim 4, wherein the lid switch is ON when the lid is positioned in the open position or the push start position and is OFF when the lid is positioned in the closed position or the pushed-in position,
in a case where the lid switch is turned from OFF to ON before the first predetermined time elapses from a time point where the lid switch is turned from ON to OFF due to displacement of the lid from the push start position to the pushed-in position, the control device makes the indicator display the open state when the lid switch status continues to be the open state for the second predetermined time from a time point where the lid switch is turned from OFF to ON due to displacement of the lid from the closed position to the push start position, and
in a case where the lid switch is turned from OFF to ON after the first predetermined time has elapsed from the time point where the lid switch is turned from ON to OFF due to displacement of the lid from the push start position to the pushed-in position, the control device makes the indicator display the open state when the lid switch status continues to be the open state for the second predetermined time from the time point where the lid switch is turned from OFF to ON due to displacement of the lid from the pushed-in position to the push start position.

7. The lid device according to claim 1, wherein the lid switch comprises an operation rod extending in a direction toward and away from an inner surface of the lid in the closed position and supported to be movable in an axial direction and a switch operation member that operates in accordance with displacement of the operation rod in the axial direction, and
the operation rod has a first recess and a second recess provided to be arranged side by side in the axial direction such that the switch operation member is engaged with the first recess when the lid is displaced to the closed position and is engaged with the second recess when the lid is displaced to the pushed-in position.
